(19) United States
(12) Patent Application Publication
(10) Pub. No.: US 2026/0028000 A1
(43) Pub. Date: Jan. 29, 2026

(54) Electro-Mechanical Brake And Control Method Therefor

(71) Applicant: HYUNDAI MOBIS CO., LTD., Seoul (KR)

(72) Inventor: Dong Hwan LIM, Yongin-si (KR)

(73) Assignee: HYUNDAI MOBIS CO., LTD., Seoul (KR)

(21) Appl. No.: 19/262,749

(22) Filed: Jul. 8, 2025

(30) Foreign Application Priority Data
Jul. 24, 2024 (KR) 10-2024-0098123

(51) Int. Cl. B60T 8/171; B60T 13/74

(52) U.S. Cl. CPC B60T 8/171; B60T 13/746; B60T 2270/84

(57) ABSTRACT

Disclosed are an electro-mechanical brake apparatus and a control method therefor.

According to an embodiment of the present disclosure, there is provided a control method of electro-mechanical brake apparatus including a piston configured to push a brake pad toward a wheel disk by driving a motor, the method including determining whether a brake pedal is depressed, when it is determined that the brake pedal is not depressed, determining whether an accelerator pedal is depressed, when it is determined that the accelerator pedal is depressed, determining whether a vehicle is stopped, when it is determined that the vehicle is not stopped, determining whether the vehicle is performing vehicle body posture control, and when it is determined that the vehicle is not performing the vehicle body posture control, controlling an air gap, wherein the air gap includes a spacing distance between the brake pad and the wheel disk.

### CROSS-REFERENCE TO RELATED APPLICATION

The present application claims priority to Korean Patent Application No. 10-2024-0098123, filed on Jul. 24, 2024, the entire contents of which is incorporated herein for all purposes by this reference.

### TECHNICAL FIELD

The present disclosure relates to an electro-mechanical brake apparatus and a control method thereof.

### BACKGROUND

The content described in this section merely provides background information for the present disclosure, but does not constitute the related art.

An electro-mechanical brake (EMB) is a brake apparatus that generates a friction brake force. In the electro-mechanical brake, an actuator driven by a motor is mounted on a brake caliper. The electro-mechanical brake presses the wheel disk using motor, gear box, screw, piston, brake pad, or the like without a medium called brake fluid.

The electro-mechanical brake has a mechanism similar to that of an electronic parking brake (EPB), but since the electro-mechanical brake is a main brake apparatus used during driving, higher reliability, higher durability, and the like are required.

When the driver depresses the pedal, the electro-mechanical brake calculates the required brake force and applies a brake command to each wheel. When the brake command is applied, the motor starts to rotate to advance the piston, and the piston presses the brake pad. The brake pads press the wheel disks so that the brake force is generated.

A conventional electro-mechanical brake (EMB) measures a brake force by using a force sensor and controls the brake force. A force sensor mounted on the electro-mechanical brake is expensive. In addition, the force sensor has the disadvantage of not being able to accurately measure the brake force depending on the mounted position. To overcome these drawbacks, a force sensor-less system is used.

The force sensor-less system is understood to mean the system which estimates the brake force without the use of the force sensor. The electro-mechanical brake to which the force sensor-less system is applied performs calibration. Here, the calibration means the setting the electro-mechanical brake. The electro-mechanical brake may perform calibration to ascertain the brake force value corresponding to the position of the piston. A map in which brake force values corresponding to the positions of the pistons are indexed is referred to as a force map. By means of the force map, the electro-mechanical brake may determine the brake force without the force sensor and adjust the brake force.

Since a state of the electro-mechanical brake changes according to use, such as wear of the brake pad, it is necessary to update information of the electro-mechanical brake by performing calibration every time the vehicle is used. By performing the calibration, the air gap, which is a spacing distance between the brake pad and the wheel disk in a home position in which the braking command is not applied, may be adjusted. The calibration is preferably carried out before starting the traveling. For example, when the driver opens a door of the vehicle or starts the vehicle, calibration may be performed and a force map may be generated.

That is, the electro-mechanical brake utilizing the force sensor-less system may perform calibration to ascertain the current state of the electro-mechanical brake and generate data for estimating the brake force. It is important that the calibration is terminated in a short time. This is because the driver may travel after the calibration is completed.

Calibration is generally performed only when the driver opens or starts the door of the vehicle. It is undesirable to perform calibration while traveling. This is because the calibration process includes a process of driving the motor to move the piston and the brake pad and a process of generating the brake force. When the calibration is performed irrespective of the will of the driver while traveling, the driver may feel a brake heterogeneity, and a traffic accident may occur.

The force map generated when the driver opens or starts the door of the vehicle reflects only the state of the electro-mechanical brake at the time of generation. The force map does not reflect the changed state of the electro-mechanical brake in real time by performing braking during traveling. For example, when braking is performed while traveling, the brake pad may expand due to heat. In addition, the caliper including the brake pad may tilt due to the movement of a load during acceleration or deceleration of the vehicle, such as rotation or rapid deceleration during running of the vehicle. The phenomenon in which the caliper tilts is a natural phenomenon that occurs while the vehicle is running.

As described above, in a case where the state of the electro-mechanical brake is different from the state at the time point at which the force map is generated due to the braking performed during traveling, a drag phenomenon, which is a phenomenon in which the brake pad and the wheel disk are in contact with each other, may occur even in a case where a braking command is not applied. A slight drag phenomenon may cause a driving force loss of the vehicle while the vehicle is running, resulting in a decrease in fuel efficiency. In addition, a significant drag phenomenon may cause the temperature of the brake pad to rise and cause a fire while the vehicle is running.

There is a need for a method that may prevent a drag phenomenon without performing additional calibration while the vehicle is traveling. This is because it is not preferable to perform calibration during operation as described above.

The drag phenomenon may be prevented by additionally securing an air gap. However, when the air gap is additionally secured, there is a problem in that a distance to a contact point at which the brake pad comes into contact with the wheel disk to generate a brake force is increased. In this case, there is a problem in that a section in which the brake pad moves to the contact point becomes long and the braking responsiveness deteriorates.

Therefore, there is a need for a method that may minimize the drag phenomenon while maintaining rapid braking responsiveness.

### SUMMARY

A main object of a method for controlling an electro-mechanical brake apparatus according to an embodiment is to provide a method capable of minimizing a drag phenomenon without performing additional calibration when the state of the electro-mechanical brake apparatus is changed from a state before traveling due to braking performed during traveling.

In addition, a method of controlling the electro-mechanical brake apparatus according to an embodiment has a main object of providing a method of minimizing a drag phenomenon and maintaining a rapid braking responsiveness.

The problems to be solved by the present invention are not limited to the above-mentioned problems, and other problems that are not mentioned will be clearly understood by those skilled in the art from the following description.

### Solution to Problem

According to an embodiment of the present disclosure, there is provided a control method of electro-mechanical brake apparatus including a piston configured to push a brake pad toward a wheel disk by driving a motor, the method including determining whether a brake pedal is depressed, when it is determined that the brake pedal is not depressed, determining whether an accelerator pedal is depressed, when it is determined that the accelerator pedal is depressed, determining whether a vehicle is stopped, when it is determined that the vehicle is not stopped, determining whether the vehicle is performing vehicle body posture control, and when it is determined that the vehicle is not performing the vehicle body posture control, controlling an air gap, wherein the air gap includes a spacing distance between the brake pad and the wheel disk.

According to an embodiment of the present disclosure, there is provided an electro-mechanical brake apparatus including a piston configured to push a brake pad toward a wheel disk by driving a motor, the electro-mechanical brake apparatus including an accelerator pedal sensor configured to detect an accelerator pedal stroke, a brake pedal sensor configured to detect whether a brake pedal is depressed, a vehicle speed sensor configured to be able to determine whether an accelerator pedal is depressed while a gear of the vehicle is in a parking mode or a neutral mode, and a processor, wherein the processor includes determining whether the brake pedal is depressed, when it is determined that the brake pedal is not depressed, determining whether the accelerator pedal is depressed, when it is determined that the accelerator pedal is depressed, determining whether a vehicle is stopped, when it is determined that the vehicle is not stopped, determining whether the vehicle is performing vehicle body posture control, and when it is determined that the vehicle is not performing the vehicle body posture control, controlling an air gap, wherein the air gap refers to a spacing distance between the brake pad and the wheel disk, the controlling the air gap includes controlling the air gap based on the accelerator pedal stroke.

### Advantageous Effects

The control method of the electro-mechanical brake apparatus according to an embodiment has an effect of minimizing the drag phenomenon without performing additional calibration when the state of the electro-mechanical brake is changed from the state before traveling due to braking performed during traveling.

In addition, the control method of the electro-mechanical brake apparatus according to an embodiment has an effect of minimizing the drag phenomenon and maintaining the rapid braking responsiveness.

As described above, according to the present embodiment, the electro-mechanical brake apparatus has an effect of being able to accurately detect the actual brake force value without performing additional calibration when the state of the electro-mechanical brake apparatus is changed from the state before traveling due to braking performed during traveling.

### BRIEF DESCRIPTION OF THE DRAWINGS

FIG. 1 is a functional block diagram of the electro-mechanical brake according to an embodiment of the present disclosure.

FIG. 2 is a diagram illustrating the brake force generating unit according to an embodiment of the present disclosure.

FIG. 3 is a diagram illustrating the state in which the caliper of the brake force generating unit controls the air gap in a tilted state due to the movement of the load during traveling of the vehicle according to an embodiment of the present disclosure.

FIG. 4 is a flowchart illustrating the method of controlling the air gap by the electro-mechanical brake according to an embodiment of the present disclosure.

FIG. 5 is a graph showing the accelerator pedal stroke of the driver with respect to time.

FIG. 6 is a flowchart illustrating step S550 of FIG. 4.

FIG. 7 is a graph illustrating a first map.

FIG. 8 is a flowchart illustrating step S630 of FIG. 6.

FIG. 9 is a graph showing the air gap adjustment amount, the current of the motor, and the RPM of the motor with respect to the accelerator pedal stroke of the occupant.

### DETAILED DESCRIPTION

Hereinafter, some embodiments of the present disclosure will be described in detail with reference to exemplary drawings. Note that when components in each drawing are denoted by reference numerals, the same components are denoted by the same numerals as much as possible even if they are denoted on different drawings. In addition, in describing the present disclosure, if it is determined that a specific description of a related known configuration or function May obscure the gist of the present disclosure, the detailed description thereof will be omitted.

In describing components of embodiments of the present disclosure, reference numerals such as first, second, i), ii), a), and b) may be used. These symbols are only used to distinguish the components from other components, and the nature, sequence, order, or the like of that component is not limited by the symbols. Throughout the specification, when it is stated that a certain portion “includes” or “comprises” a specific component, it shall be understood that, unless explicitly otherwise specified, this does not exclude other components but may further include additional components.

The description set forth below in connection with the appended drawings is intended to describe exemplary embodiments of the disclosure and is not intended to represent the only embodiments in which the disclosure may be practiced.

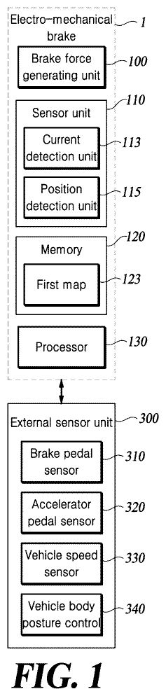

FIG. 1 is a functional block diagram of the electro-mechanical brake according to an embodiment of the present disclosure.

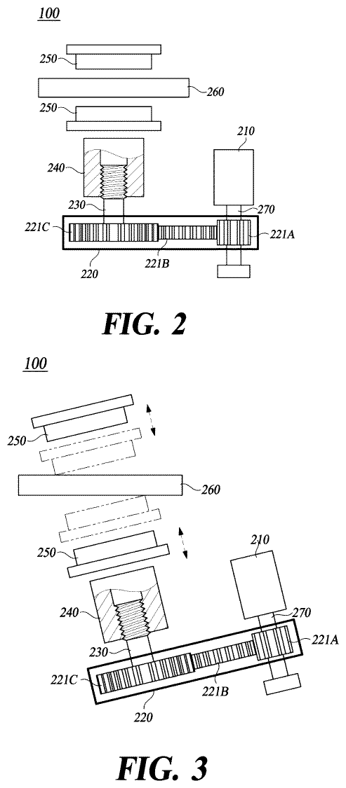

FIG. 2 is a diagram illustrating the brake force generating unit according to an embodiment of the present disclosure.

FIG. 3 is a diagram illustrating a state in which a caliper of a brake force generating unit controls the air gap in a tilted state due to a movement of a load during traveling of a vehicle according to an embodiment of the present disclosure.

Referring to FIGS. 1 to 3, the electro-mechanical brake (EMB) 1 includes all or a part of the brake force generating unit 100, the sensor unit 110, the memory 120, and processor 130.

The electro-mechanical brake 1 generates a friction brake force. The electro-mechanical brake 1 does not use hydraulic pressure, resulting in a faster response speed and being more environmentally friendly compared to a hydraulic brake (not shown). The electro-mechanical brake 1 is capable of independently controlling each wheel (not shown), thereby enhancing braking stability.

When the driver depresses a brake pedal (not shown), the brake force generating unit 100 calculates a necessary brake force based on a stroke amount of the driver, and then generates the brake force. The brake force generating unit 100 may be mounted on the wheel of the vehicle to generate the brake force. The brake force generating unit 100 may be mounted on each wheel of the vehicle. The brake force generating unit 100 may independently generate and independently control the brake force for each wheel. The brake force generating unit 100 brakes the vehicle by changing the kinetic energy of the vehicle in the form of thermal energy using the frictional force.

The brake force generating unit 100 may include all or a part of motor 210, gear box 220, power transfer unit 230, piston 240, brake pad 250, rotation shaft 270, and wheel disk 260. The brake force generating unit 100 is not limited by the disclosure of the drawings. For example, the shape, size, arrangement, and the like of the motor 210, the gear box 220, the power transfer 230, the piston 240, the brake pad 250, the rotation shaft 270, and the wheel disk 260 are not limited by the disclosure of the drawings.

The motor 210 rotates to move the piston 240. As used herein, the direction of the piston is defined. Front means the direction in which the piston 240 faces the wheel disk 260. The rear side means a direction in which the piston 240 faces the opposite direction of the wheel disk 260. The forward movement means the case where the piston 240 moves toward the wheel disk 260. The backward movement means the case where the piston 240 moves in the opposite direction to the wheel disk 260.

According to an embodiment, the motor 210 may be DC motor, AC motor, induction motor, synchronous motor, step motor, servo motor, Brushless Direct Current (BLDC) motor, linear motor, Permanent Magnet Synchronous Motor (PMSM), or the like.

One side of the gear box 220 is connected to the motor 210, and the other side of the gear box 220 is connected to the power transfer 230. The gear box 220 is configured to transfer power of the motor 210 to the power transfer 230. The gear box 220 includes a plurality of gears 221 therein. The gear box 220 may boost the rotational force by meshing and rotating the plurality of gears 221. The shape and arrangement of the gear box 220 are not limited by the drawings. Each of the plurality of gears 221 is not limited to the shape and number disclosed in the drawings.

The power transfer 230 may receive power from the gear box 220. The power transfer 230 may provide power to the piston 240.

According to an embodiment, the power transfer 230 may be a screw shaft. In this case, the piston 240 may be screw coupled to the screw shaft. When the screw shaft rotates, the screw connection be connected or disconnected, the piston 240 move forward or backward.

The piston 240 receives power from the power transfer 230 and moves. When piston 240 moves forward, piston 240 presses on brake pad 250. The brake pad 250 presses the rotating wheel disk 260 to brake the vehicle.

The brake pads 250 may be a pair. A pair of brake pads 250 may be disposed on either side of the wheel disk 260. The wheel disk 260 is coupled to and rotates with the wheels of the vehicle. When the piston 240 presses the brake pad 250, the brake pad 250 may press the wheel disk 260. When the brake pad 250 presses the wheel disk 260, the brake pad 250 is compressed and a brake force is generated. As the distance that the piston 240 moves forward increases, the brake force increases because the force with which the brake pad 250 presses the wheel disk 260 increases.

The sensor 110 may include current detection unit 113, position detection unit 115, and the like.

According to an embodiment, the current detection unit 113 may detect a current flowing through the motor 210. For example, a current sensor (not shown) may be included to detect a current flowing through the motor 210. The electro-mechanical brake 1 may control a current flowing through the motor 210 by using the current detection unit 113.

According to an embodiment, the position detection unit 115 may detect the current flowing through the piston 240. For example, the position detection unit 115 may detect rotation angle of the motor 210. The rotation of the motor 210 causes the piston 240 to move forward or backward. That is, since the position of the piston 240 is determined by the rotation angle of the motor 210, the electro-mechanical brake 1 may detect the position of the piston 240 using the position detection unit 115 with motor rotation angle sensor.

The processor 130 may detect piston position-based estimated brake force values based on the position of the piston 240 detected by the position detector 115.

The processor 130 may detect current-based estimated brake force values based on the current values of the motor 210 detected by the current detector 113.

The processor 130 may determine that the state of the brake pad 250 has changed from the initial state to another state when the piston position-based estimated brake force values and the current-based estimated bracing force values are different values from each other.

The processor 130 may receive a signal from the external sensor unit 300. The external sensor unit 300 may include a brake pedal sensor 310, an accelerator pedal sensor 320, a vehicle speed sensor 330, a vehicle body posture control sensor 340, and the like.

The brake pedal sensor 310 may detect whether the driver depresses the brake pedal and a depressing stroke of the brake pedal. As a result, the strength of the brake force desired by the driver may be determined.

The accelerator pedal sensor 320 may detect whether the driver depresses the accelerator pedal and a depressing stroke of the accelerator pedal.

The vehicle speed sensor 330 may measure a current speed of the vehicle and transmit a stand still signal that is a stop signal of the vehicle.

The vehicle body posture control sensor 340 may detect whether the vehicle body control system is in operation. The vehicle body posture control sensor 340 may be a Yaw Rate sensor (not shown), a steering angle sensor (not shown) or a roll angle sensor (not illustrated).

When determining that the state of the brake pad 250 is different from the initial state, the processor 130 may instruct to perform a process of controlling the air gap based on the states of the vehicle detected by the brake pedal sensor 310, the accelerator pedal sensor 320, the vehicle speed sensor 330, and the vehicle body posture control sensor 340. Here, the air gap means a spacing distance between the brake pad 250 and the wheel disk 260.

A first map 123 is stored in the memory 120. The first map 123 may be a look-up table indicating a correlation between the stroke of the accelerator pedal and the air gap adjustment amount. The first map 123 will be described in detail later.

As used herein, a state of the electro-mechanical brake 1 is defined. The first state refers to a state of the electro-mechanical brake 1 when driving and braking have not been performed yet. For example, the first state may be a state of the electro-mechanical brake 1 when power is applied to the vehicle by starting. For example, the first state may be a state of the electro-mechanical brake 1 when a door of a vehicle whose start is turned off is opened.

As used herein, the term initial state is used synonymously with the first state described above. During running, the state of the electro-mechanical brake 1 may change from the first state (initial state) to another state. For example, when braking is performed while traveling, the brake pad 250 may expand due to heat. For example, referring to FIG. 3, a caliper including a brake pad 250 may tilt due to movement of a load, such as rotation, rapid acceleration, or rapid deceleration, while the vehicle is traveling. As a result, even when the braking command is not applied, a drag phenomenon, which is a phenomenon in which the brake pad 250 and the wheel disk 260 are in contact with each other, may occur. A slight drag phenomenon may cause a driving force loss of the vehicle during vehicle running, resulting in a decrease in fuel efficiency. In addition, a significant drag phenomenon may cause the temperature of the brake pad 250 to rise and cause a fire while the vehicle is running. The drag phenomenon may be prevented by additionally securing the air gap. The piston 240 moves rearward, so that the air gap may be further secured.

However, when an additional air gap is unconditionally secured, there is a problem in that a distance to a contact point at which the brake pad 250 comes into contact with the wheel disk 260 to generate a brake force is increased. In this case, there is a problem in that the section in which the brake pad 250 moves to the contact point becomes long and the braking responsiveness deteriorates.

Hereinafter, a method of controlling the air gap capable of minimizing a drag phenomenon while maintaining rapid braking responsiveness will be described.

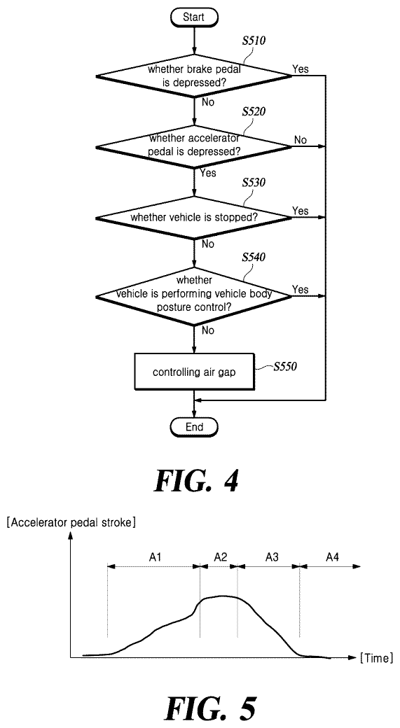

FIG. 4 is a flowchart illustrating a method of controlling the air gap by the electro-mechanical brake according to an embodiment of the present disclosure.

Referring to FIG. 4, the electro-mechanical brake 1 according to an embodiment of the present disclosure may detect whether a driver depresses a brake pedal (S510). When the driver depresses the brake pedal and applies a braking command, controlling the air gap may not generate a brake force appropriate to the situation. Therefore, the process of controlling the air gap may be performed only when the driver is not depressing the brake pedal.

The electro-mechanical brake 1 according to an embodiment of the present disclosure may detect whether the driver is depressing the accelerator pedal (S520). This is to control the air gap only when the driver is depressing the accelerator pedal. This is because the brake force does not need to be generated when the driver depresses the accelerator pedal. In order for the vehicle to perform braking, the driver releases the depressing of the accelerator pedal and performs braking by depressing the brake pedal. Therefore, when the driver releases the depressing of the accelerator pedal, the process of controlling the air gap for rapid braking responsiveness may not be performed.

FIG. 5 is a graph showing the accelerator pedal stroke of the driver with respect to time.

Referring to FIG. 5, section A1 is an acceleration section, and is a section in which the driver desires to accelerate. Section A2 is a constant speed section, and is a section in which acceleration desired by the driver is completed and the vehicle is traveling at a constant speed. Section A3 is a first deceleration section, and is a section in which the driver wants to decelerate but may be willing to accelerate again. Section A4 is a second deceleration section, and is a coasting section in which the driver does not intend to accelerate. The section A4 is a section in which the driver's braking command may be applied. Therefore, the process of controlling the air gap is performed in sections A1, A2, and A3, and the existing air gap is maintained in the section A4, so that the rapid braking responsiveness may be maintained and the drag phenomenon may be minimized.

The electro-mechanical brake 1 according to an embodiment of the present disclosure May detect whether the driver depresses the accelerator pedal while the gear is in the parking mode or the neutral mode while the driver is stopped (S530). Whether the driver depresses the accelerator pedal while the gear is in the parking mode or the neutral mode while the vehicle is stopped may be determined based on the stand still signal of the vehicle speed sensor 330. When the air gap control process is performed while the vehicle is stopped, vibration and noise of the motor 210 may be transmitted to the occupant. Therefore, when the vehicle is not stopped, the process of controlling the air gap may be performed.

The electro-mechanical brake 1 according to an embodiment of the present disclosure may detect whether the vehicle is performing the vehicle body posture control (S540). The vehicle body posture control may be VDC, ABS, or the like. Rapid braking responsiveness may be important for vehicle body attitude control. Therefore, a process of controlling the air gap during performing the vehicle body posture control may not be appropriate. Therefore, the process of controlling the air gap may be performed only when the vehicle body posture control is not being performed.

That is, the electro-mechanical brake 1 according to an embodiment of the present disclosure may perform a process of controlling the air gap when the driver does not depress the brake pedal, the accelerator pedal is being depressed, the vehicle is not stopped, and the vehicle body posture control is not being performed.

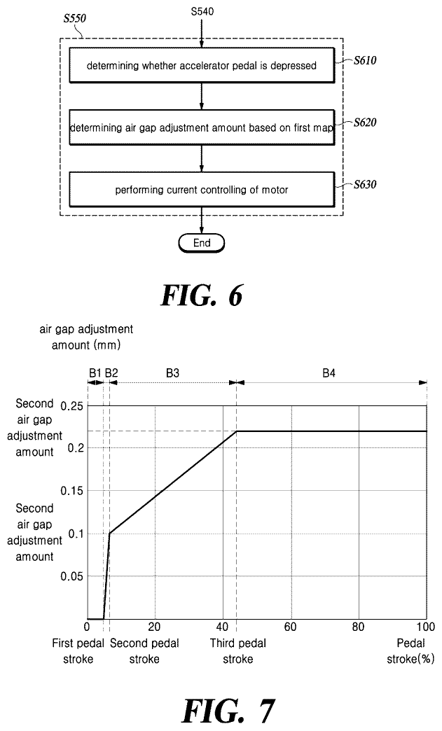

A process of S550 according to an embodiment will be described in more detail with reference to FIGS. 6 to 9.

FIG. 6 is a flowchart illustrating step S550 of FIG. 4.

FIG. 7 is a graph illustrating a first map.

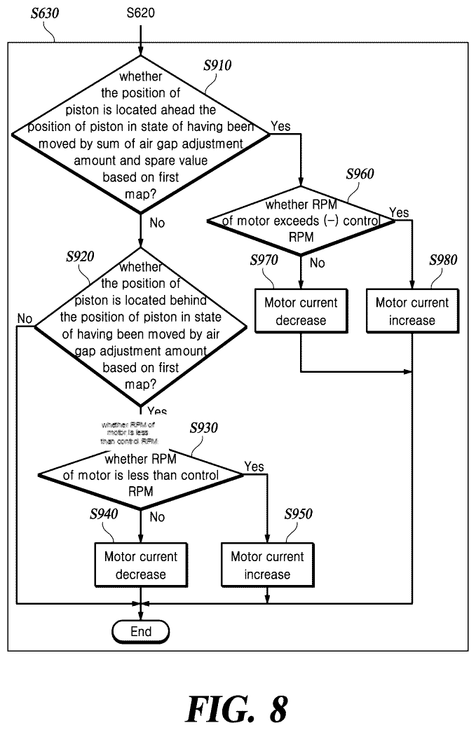

FIG. 8 is a flowchart illustrating step S630 of FIG. 6.

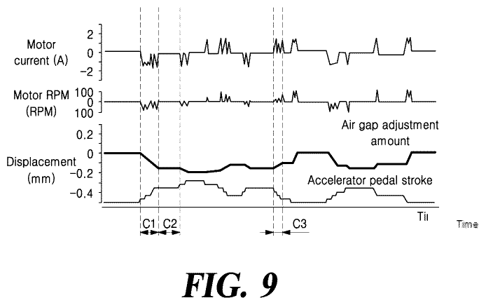

FIG. 9 is a graph showing the air gap adjustment amount, the current of the motor, and the RPM of the motor with respect to the accelerator pedal stroke of the occupant.

Referring to FIGS. 6 to 9, the electro-mechanical brake 1 according to an embodiment of the present disclosure may limit the RPM of the motor 210 by controlling the current of the motor 210 in real time, and control the air gap corresponding to the stroke of the accelerator pedal.

The electro-mechanical brake 1 according to an embodiment of the present disclosure May detect a stroke of an accelerator pedal of a driver in real time (S610).

The electro-mechanical brake 1 according to an embodiment of the present disclosure May determine the air gap adjustment amount based on the first map 123 in real time (S620). Referring to FIG. 7, the first map 123 may include sections B1, B2, B3, and B4.

Section B1 may be a section in which the accelerator pedal stroke is greater than or equal to 0% and less than the first pedal stroke. The first pedal stroke may be approximately 5%. The air gap adjustment amount of the section B1 may be 0 mm. That is, it is possible to maintain an existing air gap. This is because, when the air gap is adjusted by depression of a fine accelerator pedal, the driver may feel a brake heterogeneity. In addition, this is to ensure rapid brake responsiveness in the case of a depression state of a fine accelerator pedal.

Section B2 may be a section in which the accelerator pedal stroke is equal to or greater than the first pedal stroke and equal to or less than the second pedal stroke. When the accelerator pedal stroke is the second pedal stroke, the air gap adjustment amount may be the first air gap adjustment amount. The first airgap adjustment amount may be approximately 0.1 mm. The first amount of airgap adjustment may be a minimum value that may cause a caliper sag phenomenon or drag when the brake pad 250 is inflated. The section B2 may be a section in which the airgap adjustment amount increases linearly from 0 mm to the first airgap adjustment amounts. However, the increasing trend of the section B2 is not necessarily limited thereto.

Section B3 may be a section in which the accelerator pedal stroke is greater than the second pedal stroke and less than or equal to the third pedal stroke. When the accelerator pedal stroke is the third pedal stroke, the air gap adjustment amount may be the second air gap adjustment amount. The second airgap adjustment amount may be approximately 0.22 mm. The second airgap adjustment amount may be a maximum value capable of eliminating the drag phenomenon and providing rapid braking responsiveness at the same time. The section B3 may be a section in which the airgap adjustment amount increases linearly from the first airgap adjustment amounts to the second airgap adjustment quantities. However, the increasing trend of the section B3 is not necessarily limited thereto.

Section B4 may be a section in which the accelerator pedal stroke is greater than the third pedal stroke and less than or equal to 100%. The section B4 may be a section in which the air gap adjustment amount is maintained at the second air gap adjustment amount.

When the air gap adjustment amount is determined in operation S620, the electro-mechanical brake 1 according to an embodiment of the present disclosure may control the current of the motor 210 (operation S630). The current control process of the motor 210 is a process of limiting the RPM of the motor 210 by controlling the current of the motor 210 to move the piston 240. The piston 240 may control the airgap by moving based on the first map 123. The electro-mechanical brake 1 is set so that the control of the motor 210 has fast responsiveness due to its characteristics. The motor 210 may be driven at a high RPM to have a fast responsiveness, resulting in noise. However, the process of controlling the air gap S550 does not require fast responsiveness, and it is required to reduce noise.

Hereinafter, a current control process of the motor 210 will be described in detail with reference to FIG. 8.

The electro-mechanical brake 1 according to an embodiment of the present disclosure may detect whether the current position of the piston 240 is located in front of the position of the piston 240 having moved by the sum of the air gap adjustment amount and the spare value determined in step S620 (S910). The spare value is a value within an error range in which the piston 240 may be located, and may be approximately 0.01 mm. However, the present invention is not necessarily limited thereto, and may be changed depending on other circumstances such as the specifications of the brake pad 250.

The electro-mechanical brake 1 according to an embodiment of the present disclosure May detect whether the RPM of the motor 210 exceeds the (−) control RPM when it is determined that the current position of the piston 240 is located in front of the position of the piston 240 having moved by the sum of the air gap adjustment amount and the spare value determined in step S620 (S960). Here, a negative sign means a reverse direction, and the rotation shaft 270 of the motor 210 rotates in the reverse direction, whereby the piston 240 may move backward. Here, the control RPM may be approximately 100 RPM. Thus, the (−) control RPM may be approximately (−) 100 RPM. However, the present invention is not necessarily limited thereto.

When it is determined that the RPM of the motor 210 exceeds the (−) control RPM, the electro-mechanical brake 1 according to an embodiment of the present disclosure may increase the current of the motor 210 by a unit control current value (S980). Here, the unit control current value means approximately 0.05 A. However, the present invention is not necessarily limited thereto, and may be changed in accordance with the accuracy of control.

When it is determined that the RPM of the motor 210 is equal to or less than the (−) control RPM, the electro-mechanical brake 1 according to an embodiment of the present disclosure may reduce the current of the motor 210 by a unit control current value (S970). Here, the unit control current value means approximately 0.05 A. However, the present invention is not necessarily limited thereto, and may be changed in accordance with the accuracy of control.

When the electro-mechanical brake 1 according to an embodiment of the present disclosure determines that the current position of the piston 240 is located rearward of the position of the piston 240 having moved by the sum of the air gap adjustment amount and the spare value determined in step S620, the electro-mechanical brake 1 may detect whether the current position of each piston 240 may be located rearward of a position of a piston 240 having moved by the air gap adjustment amount determined by step S620 (step S920).

The electro-mechanical brake 1 according to an embodiment of the present disclosure may detect whether the RPM of the motor 210 is less than the control RPM when it is determined that the current position of the piston 240 is located rearward of the position of the piston 240 having moved by the air gap adjustment amount determined in step S620 (S930). Here, the positive sign is omitted, and in this case, the rotation shaft 270 of the motor 210 rotates in the positive direction, so that the piston 240 may move forward. Here, the control RPM may be approximately 100 RPM. However, the present invention is not necessarily limited thereto.

When it is determined that the RPM of the motor 210 is less than the control RPM, the electro-mechanical brake 1 according to an embodiment of the present disclosure may increase the current of the motor 210 by a unit control current value (S950). Here, the unit control current value means approximately 0.05 A. However, the present invention is not necessarily limited thereto, and may be changed in accordance with the accuracy of control.

When it is determined that the RPM of the motor 210 is equal to or greater than the control RPM, the electro-mechanical brake 1 according to an embodiment of the present disclosure May reduce the current of the motor 210 by a unit control current value (S940). Here, the unit control current value means approximately 0.05 A. However, the present invention is not necessarily limited thereto, and may be changed in accordance with the accuracy of control.

Each component of the apparatus or method according to the present disclosure may be implemented by hardware or software, or may be implemented by a combination of hardware and software. In addition, a function of each component may be implemented in software, and a microprocessor may be implemented to execute a function of the software corresponding to each component.

Referring to FIG. 9, the accelerator pedal stroke graph shows a relative change amount of the accelerator pedal stroke irrespective of the absolute value of the vertical axis. The air gap adjustment amount means a displacement in which the piston 240 is moved backward, and thus may be expressed as the negative number on the vertical axis.

Section C1 may correspond to the section A1 in FIG. 5. In the section C1, the motor 210 is driven at the negative RPM, so that the piston 240 moves backward, and the air gap adjustment amount may be linearly increased.

Section C2 may correspond to the section A2 in FIG. 5. The air gap adjustment amount may be maintained in the C2 section.

Section C3 may correspond to the section A3 in FIG. 5. In the C3 section, the motor 210 is driven with a positive RPM, so that the piston 240 moves forward and the air gap adjustment amount may be linearly reduced.

Various implementations of the systems and techniques described herein may be realized in digital electronic circuitry, integrated circuitry, field programmable gate arrays (FPGAs), application specific integrated circuits (ASICs), computer hardware, firmware, software, and/or combinations thereof. These various implementations may include implementation in one or more computer programs that are executable on a programmable system. The programmable system includes at least one programmable processor (which may be a special-purpose processor or a general-purpose processor) coupled to receive data and commands from, and to transmit data and commands to, storage systems, at least one input device, and at least one output device. Computer programs (also known as programs, software, software applications, or code) include commands for a programmable processor and are stored in a “computer readable recording medium”.

The computer-readable recording medium includes all kinds of recording devices in which data that may be read by a computer system is stored. The computer-readable recording medium may be a non-volatile or non-transitory medium such as ROM, CD-ROM, magnetic tape, floppy disk, memory card, hard disk, magneto-optical disk, or storage device, and may further include transitory medium such as data transmission medium. In addition, the computer-readable recording medium may be distributed in a network-connected computer system, and the computer-readable code may be stored and executed in a distributed manner.

In the flowcharts/timing diagrams of the present specification, each process is described as being executed sequentially, however, this is merely an example of the technical idea of an embodiment of the present disclosure. In other words, the flowcharts/timing diagrams are not limited to a chronological order, as those skilled in the art may make various modifications and variations to the sequence of the flowchart/timing diagram or to perform one or more of the processes in parallel without departing from the essential characteristics of the embodiments of the present disclosure.

The foregoing descriptions are merely illustrative of the technical idea of the present embodiment, and various modifications and variations may be made by those skilled in the art without departing from the essential characteristics of the present embodiment. Therefore, the present embodiments are not intended to limit the technical idea of the present embodiments, but are intended to be illustrative, and the scope of the technical idea of this embodiment is not limited by these embodiments. The protection scope of the present embodiment is to be construed according to the following claims, and all technical ideas within the scope equivalent thereto are construed as being included in the scope of rights of the present embodiment.

What is claimed is:

1. A control method of an electro-mechanical brake apparatus including a processor and a piston configured to push a brake pad toward a wheel disk by driving a motor, the control method comprising:
determining, by the processor, whether a brake pedal is depressed;
based on concluding that the brake pedal is not depressed, determining, by the processor, whether an accelerator pedal is depressed;
based on concluding that the accelerator pedal is depressed, determining, by the processor, whether a vehicle is stopped;
based on concluding that the vehicle is not stopped, determining, by the processor, whether the vehicle is performing a vehicle body posture control; and
based on concluding that the vehicle is not performing the vehicle body posture control, controlling, by the processor, an air gap;
wherein the air gap comprises a spacing distance between the brake pad and the wheel disk.

2. The control method of claim 1, wherein the determining whether the vehicle is stopped comprises:
determining, by the processor, whether the accelerator pedal is depressed in a state where a gear of the vehicle is in a parking mode or a neutral mode.

3. The control method of claim 2, wherein the controlling the air gap comprises:
controlling, by the processor, the air gap based on an accelerator pedal stroke.

4. The control method of claim 3, wherein the controlling the air gap based on the accelerator pedal stroke comprises:
using, by the processor, a first map in which an air gap adjustment amount corresponding to the accelerator pedal stroke is indexed.

5. The control method of claim 4, wherein the controlling the air gap based on the accelerator pedal stroke comprises:
based on that the accelerator pedal stroke is greater than or equal to 0% and less than a first pedal stroke, controlling, by the processor, the air gap adjustment amount to 0 mm; and
based on that the accelerator pedal stroke is equal to or greater than the first pedal stroke and equal to or less than a second pedal stroke, controlling, by the processor, the air gap adjustment amount to linearly increase from 0 mm to a first air gap adjustment amount, and
based on that the accelerator pedal stroke is greater than the second pedal stroke and less than or equal to a third pedal stroke, controlling, by the processor, the air gap adjustment amount to linearly increase from the first air gap adjustment amount up to a second air gap adjustment amount; and
based on that the accelerator pedal stroke is greater than the third pedal stroke and equal to or less than 100%, maintaining, by the processor, the air gap adjustment amount at the second air gap adjustment amount.

6. The control method of claim 5, wherein the controlling the air gap based on the accelerator pedal stroke comprises:
controlling, by the processor, a current of the motor to limit a Revolutions Per Minute (RPM) of the motor.

7. The control method of claim 6, wherein the controlling the current of the motor to limit the RPM of the motor comprises:
determining, by the processor, whether the piston is located ahead of a position of the piston in a state of having been moved by a sum of the air gap adjustment amount and a spare value based on the first map;
based on concluding that the piston is located ahead of the position of the piston in the state of having been moved by the sum of the air gap adjustment amount and the spare value based on the first map, determining, by the processor, whether the RPM of the motor exceeds a (−) control RPM;
based on concluding that the RPM of the motor exceeds the (−) control RPM, increasing, by the processor, a current value of the motor by a unit control current value; and
based on concluding that the RPM of the motor is equal to or less than the (−) control RPM, decreasing, by the processor, the current value of the motor by the unit control current value.

8. The control method of claim 7, wherein the controlling the current of the motor to limit the RPM of the motor further comprises:
based on concluding that the piston is located behind the position of the piston in the state of having been moved by the sum of the air gap adjustment amount and the spare value based on the first map, determining, by the processor, whether the piston is located behind the position of the piston in the state of having been moved by the air gap adjustment amounts based on the first map;
determining, by the processor, whether the RPM of the motor is less than the control RPM based on concluding that the piston is located behind the position of the piston in the state of having been moved by the air gap adjustment amount based on the first map;
based on concluding that the RPM of the motor is less than the control RPM, increasing, by the processor, the current value of the motor by the unit control current value; and
based on concluding that the RPM of the motor is greater than or equal to the control RPM, reducing, by the processor, the current value of the motor by the unit control current value.

9. An electro-mechanical brake apparatus comprising a piston configured to push a brake pad toward a wheel disk by driving a motor, the electro-mechanical brake apparatus comprising:
an accelerator pedal sensor configured to detect an accelerator pedal stroke;
a brake pedal sensor configured to detect whether a brake pedal is depressed;
a vehicle speed sensor configured to determine whether an accelerator pedal is depressed while a gear of the vehicle is in a parking mode or a neutral mode; and
a processor,
wherein the processor is configured for: determining whether the brake pedal is depressed; based on concluding that the brake pedal is not depressed, determining whether the accelerator pedal is depressed; based on concluding that the accelerator pedal is depressed, determining whether a vehicle is stopped; based on concluding that the vehicle is not stopped, determining whether the vehicle is performing a vehicle body posture control; and based on concluding that the vehicle is not performing the vehicle body posture control, controlling an air gap,
wherein the air gap refers to a spacing distance between the brake pad and the wheel disk, and
wherein the controlling the air gap includes controlling the air gap based on the accelerator pedal stroke.

10. The electro-mechanical brake apparatus of claim 9, wherein in the determining whether the vehicle is stopped, the processor is further configured for determining whether the accelerator pedal is depressed in a state where a gear of the vehicle is in the parking mode or the neutral mode.

11. The electro-mechanical brake apparatus of claim 10, wherein in the controlling the air gap, the processor is further configured for controlling the air gap based on an accelerator pedal stroke.

12. The electro-mechanical brake apparatus of claim 11, wherein in the controlling the air gap based on the accelerator pedal stroke, the processor is further configured for using a first map in which an air gap adjustment amount corresponding to the accelerator pedal stroke is indexed.

13. The electro-mechanical brake apparatus of claim 12, wherein in the controlling the air gap based on a degree of the accelerator pedal stroke, the processor is further configured for controlling a current of the motor to limit a revolutions per minute (RPM) of the motor.

14. The electro-mechanical brake apparatus of claim 13, wherein in the controlling the current of the motor to limit the RPM of the motor, the processor is further configured for:
determining whether the piston is located ahead of a position of the piston in a state of having been moved by a sum of the air gap adjustment amount and a spare value based on the first map;
based on concluding that the piston is located ahead of the position of the piston in the state of having been moved by the sum of the air gap adjustment amount and the spare value based on the first map, determining whether the RPM of the motor exceeds a (−) control RPM;
based on concluding that the RPM of the motor exceeds the (−) control RPM, increasing a current value of the motor by a unit control current value; and
based on concluding that the RPM of the motor is equal to or less than the (−) control RPM, decreasing the current value of the motor by the unit control current value.

15. The electro-mechanical brake apparatus of claim 14, wherein in the controlling the current of the motor to limit the RPM of the motor, the processor is further configured for:
based on concluding that the piston is located behind the position of the piston in the state of having been moved by the sum of the air gap adjustment amount and the spare value based on the first map, determining whether the piston is located behind the position of the piston in the state of having been moved by the air gap adjustment amounts based on the first map;
determining whether the RPM of the motor is less than the control RPM based on concluding that the piston is located behind the position of the piston in the state of having been moved by the air gap adjustment amount based on the first map;
based on concluding that the RPM of the motor is less than the control RPM, increasing the current value of the motor by the unit control current value; and
based on concluding that the RPM of the motor is greater than or equal to the control RPM, reducing the current value of the motor by the unit control current value.

16. The electro-mechanical brake apparatus of claim 12, wherein in the controlling the air gap based on the accelerator pedal stroke, the processor is further configured for:
based on that the accelerator pedal stroke is greater than or equal to 0% and less than a first pedal stroke, controlling the air gap adjustment amount to 0 mm; and
based on that the accelerator pedal stroke is equal to or greater than the first pedal stroke and equal to or less than a second pedal stroke, controlling the air gap adjustment amount to linearly increase from 0 mm to a first air gap adjustment amount, and
based on that the accelerator pedal stroke is greater than the second pedal stroke and less than or equal to a third pedal stroke, controlling the air gap adjustment amount to linearly increase from the first air gap adjustment amount up to a second air gap adjustment amount; and
based on that the accelerator pedal stroke is greater than the third pedal stroke and less than or equal to 100%, maintaining the air gap adjustment amount at the second air gap adjustment amount.
